(19) United States
(12) Patent Application Publication
(10) Pub. No.: US 2017/0333168 A9
(43) Pub. Date: Nov. 23, 2017

(54) Retaining device for dental blanks

(71) Applicant: Precis Glashuette GmbH, Glashutte (DE)

(72) Inventor: Roland Schuetz, Dippoldiswalde (DE)

(21) Appl. No.: 15/065,396

(22) Filed: Mar. 9, 2016

(30) Foreign Application Priority Data
Mar. 9, 2015 (DE) 102015204174.3

(51) Int. Cl. A61C 13/00; B23Q 3/06

(52) U.S. Cl. CPC A61C 13/0022; A61C 13/0006; B23Q 3/062

(57) ABSTRACT

A holding device for a dental blank for clamping the holding device in a power tool, to machine the blank by material removal, has at least one recess to accommodate the blank, and the wall of the recess has a lengthwise groove, in which a fixation element can be moved towards the center of the recess by adjustment elements. A blank arrangement comprising a holding device, as well as one cylindrical or two semi-cylindrical dental blanks, is clamped in the holding device by the adjustment elements and the fixation element. The subject innovation also relates to a method for the height-appropriate positioning of a blank in the holding device according to the subject innovation using a template, and to a method for the production of a dental sintered molded part involving the sintering of the entire dental blank with the milled-out parts contained therein.

### CROSS-REFERENCE TO RELATED APPLICATIONS

This application claims priority to German (DE) Patent Application No. 102015204174.3, filed on Mar. 9, 2015, the contents of which are incorporated by reference as if set forth in their entirety herein.

### BACKGROUND

Dental technology will change in the coming years also in view of the fact that highly specialized automation will increasingly make its way into this field, which despite being highly technical, still involves manual work. Various CAD/CAM systems are available that mill dental prosthetics out of a wide array of materials. There is a growing use of framework materials such as zirconium dioxide and alloys of non-noble metals, all of which stand out for their high strength and special geometrical properties.

Particularly in the realm of CAD/CAM milling machines for dental applications, blanks are machined on the basis of electronically prescribed data in order to employ milling to produce dental prosthetic components as well as dental models that serve as an aid for dental laboratory technicians. Such models represent complete jaws of patients or portions thereof, and they help dental laboratory technicians to produce dental prosthetic components or they serve as an aid for fitting the dental prosthetic components.

The process of milling blanks in order to produce models is described, for example, in German patent application DE 10 2009 013 153 A1.

German patent application DE 10 2010 016 847 A1 discloses the machining of blanks in order to produce dental models that correspond to the blanks that are used in dental milling machines for the production of dental restorations.

When a model or a dental restoration is produced by a machining process, considerable forces are exerted, particularly if a hard material is being used. This applies, for instance, to zirconium dioxide, which is typically machined in partially sintered form and involves the generally known drawbacks in terms of dimensional stability. Even in the case of less hard ceramics such as lithium disilicate, which is often being used nowadays, the dimensional stability and thus the precise positioning of the blank and the exact multi-axial control of the milling machine relative to the blank are useful.

According to German patent application DE 10 2009 011 443 A1, an essentially disc-shaped, flat-cylindrical blank is clamped into a standard clamp that is typically able to accommodate blanks in the standard size with a diameter of 98.5 mm. The use of such blanks permits the milling of numerous dental restorations, as described, for instance, in international patent application WO 2004/086999 A1, but this entails considerable material removal, since the milling is done using a solid element.

International patent specification WO 95/30382 discloses a device with a ring-shaped support element for holding blanks during the production of dental prosthetic components in a milling machine or other type of machining device. In that case, for cost reasons, the dental prosthetic component blank is dimensioned in such a way that the machining process wastes as little of the expensive blank material as possible. The cylindrical blank disclosed here is glued into a ring-shaped support element that can be clamped into the specific machining device and that surrounds the blank in a section of its axial length. The adhesive connection adopted here is complicated to produce and it can easily happen that adhesive residues are left behind on the blank or on the support element; if it is subsequently noticed that the blank is improperly positioned, this can no longer be corrected.

### SUMMARY

The subject innovation relates to a holding device for dental blanks and to a blank arrangement comprising this holding device as well as one or two dental blanks. The subject innovation also relates to a method for the height-appropriate positioning of a dental blank in the holding device according to the subject innovation using a template, and it also relates to a method for the production of a dental sintered molded part involving the sintering of the dental blank with the milled-out parts contained therein.

The holding device according to the subject innovation combines several advantages as compared to the holding devices known from current solutions.

The subject innovation, with adjustment elements and with its fixation element secured in a groove, allows a simple and sturdy attachment of the blank in the holding device.

Here, after the blanks have been placed into the holding device, they can be affixed in the holding device by simply actuating the adjustment elements, and this connection can be reversed equally easily.

As a result, in case of improper positioning, the blank can be released again and reattached after being correctly adjusted. Moreover, the holding device can be reused as often as desired and is not a disposable article.

Thanks to the holding device according to the subject innovation, it is now possible to remove the entire blank from the device after the dental molded part has been milled and to sinter it, so that molded parts contained therein are stabilized by the blank during the sintering process and can subsequently be separated from the blank as finished sintered molded parts, without the risk of damage. Consequently, the holding device according to the subject innovation constitutes a decisive breakthrough in the production of sintered molded parts. This production process for sintered molded parts is put forward as another aspect of the subject innovation and is being claimed accordingly.

Owing to the ring-shaped fixation element, the pressure exerted by the adjustment elements is distributed over the entire circumference of the blank so that precisely fragile blanks (for example, blanks made of porous ceramic) can be attached without the risk of damage.

Since the holding device makes it possible to dispense with a ring-shaped widening of the blank provided for the clamping in the milling machine, material is saved, which often accounts for a significant cost reduction in the case of the often very expensive materials employed in the dental sector.

The holding device according to the subject innovation consists of few components and is relatively simple to manufacture, which is reflected in low production costs.

With the holding device according to the subject innovation, the shape of the at least one recess can be freely selected, and thus adapted to the outer shape of the dental blank that is to be held in it.

In one embodiment of the subject innovation, the at least one recess of the holding device is selected from the group encompassing:
(a) a circular recess;
(b) a semi-circular recess;
(c) two semi-circular recesses separated by a web;
(d) a rectangular recess;
(e) two rectangular recesses;
(f) three, four or more rectangular recesses.

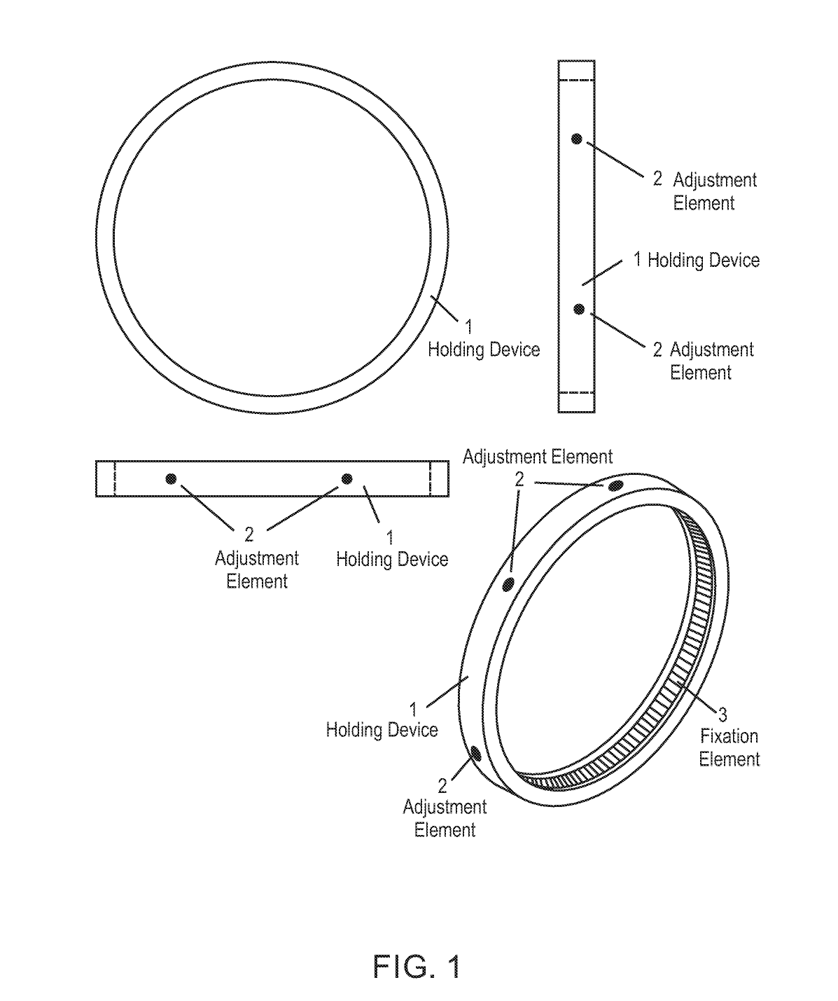

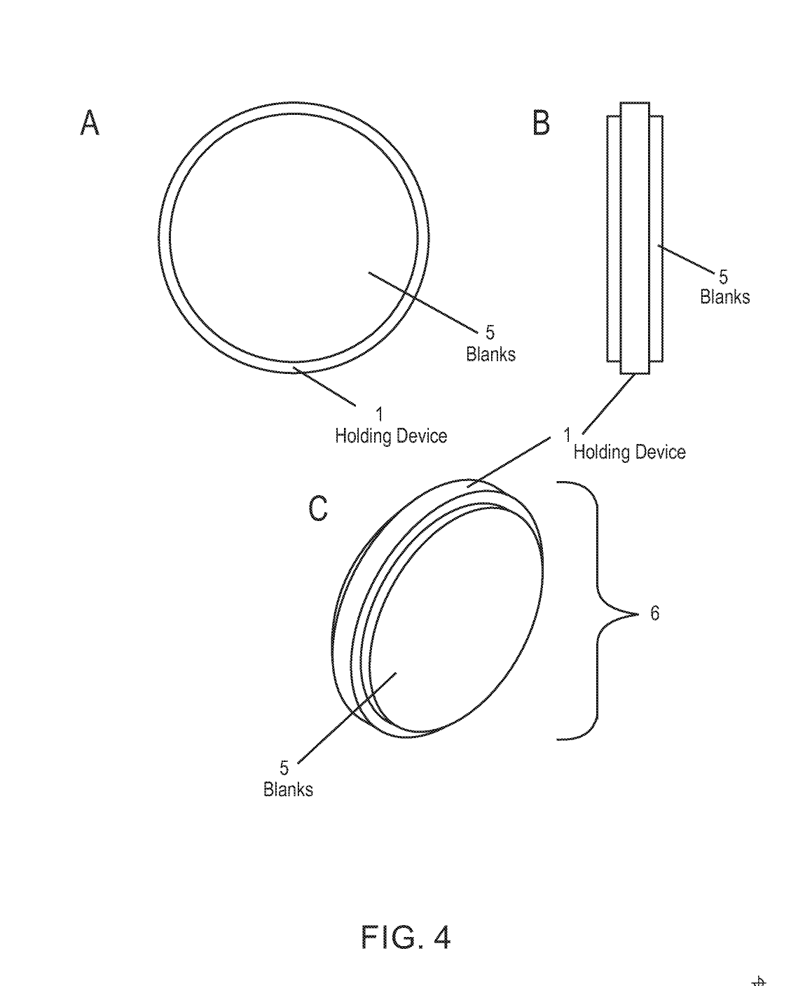

In the case of a circular recess, the holding device itself is advantageously configured as a ring (see FIG. 1 and FIG. 4).

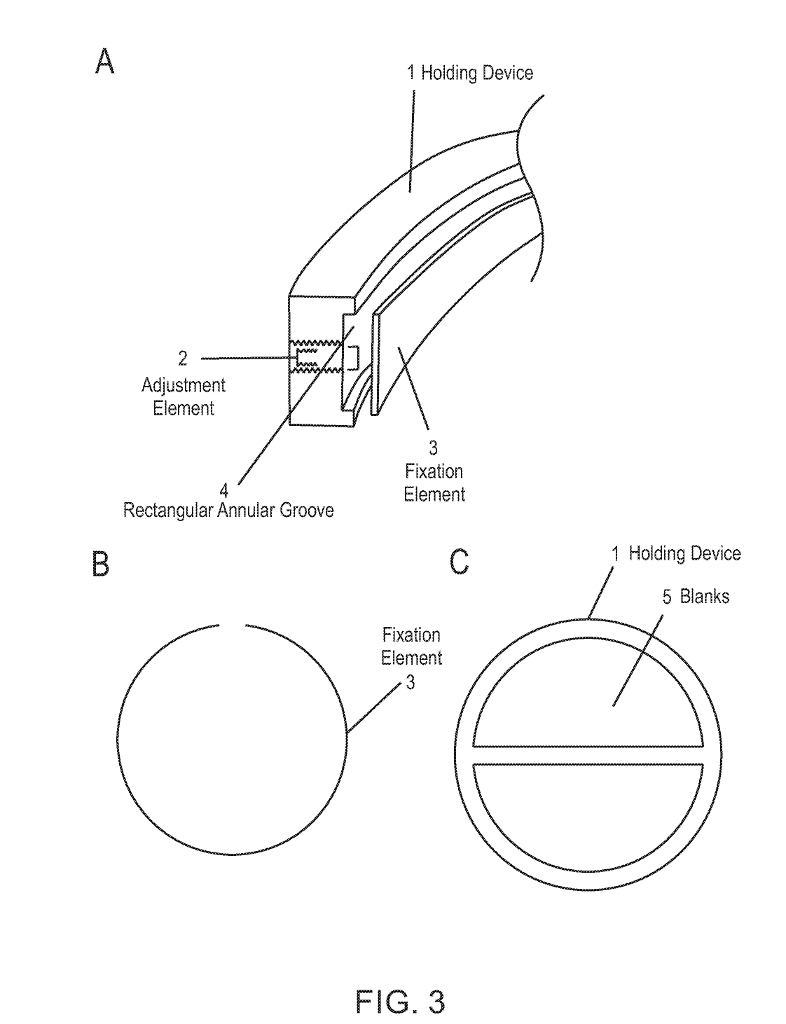

In the case of a semi-circular recess, in one embodiment, the cylindrical holding device has only this recess, in other words, it is configured as a half ring in this area. In an alternative embodiment, the ring-shaped holding device has two semi-circular recesses that are separated from each other by a web (see FIG. 3C).

The recess can have one or more rectangular recesses, in other words, for instance, two, three, four, five, six, seven or eight rectangular recesses, that each accommodate a rectangular blank. In another embodiment, these rectangular recesses can have rounded-off corners.

In the case of rectangular recesses, the fixation element is configured as a clamping jaw or clamping frame. Here, a clamping jaw is in the groove of one side of the rectangular recess, so that several clamping jaws, e.g., two or four clamping jaws, are used to affix the rectangular blank.

In an embodiment, the holding device according to the subject innovation is configured in one piece. Therefore, it is an easy-to-produce holding device that, as a result, can also exert a great deal of force on the blank that is held therein.

A clamping frame is an open three-sided or four-sided flat frame that is situated in the groove of the recess.

The outer shape of the holding device is advantageously configured in such a way that it can be placed in the dental milling machines that are generally known to the person skilled in the art, even without additional adapters and the like.

In one embodiment of the subject innovation, the fixation element is a clamping jaw, a clamping frame, a locking ring or a clamping ring. The fixation element, which may be a locking ring or a clamping ring, is situated in the lengthwise groove that is provided in the inner wall of the recess. Advantageously, the fixation element is configured in such a way that, when it is not in the affixed state, it is concealed in the groove, in other words, it does not extend into the recess. Consequently, a blank can be placed with a positive fit into the recess, so it is already brought into the desired position by the shape of the recess and affixed by the fixation elements in this prescribed position on the recess side.

The fixation element advantageously consists of a solid material that is sufficiently strong to be deformed by the adjustment elements in a reversible manner Examples of possible materials for the fixation element include metal, especially aluminum or stainless steel, plastic, especially polyacrylate, polyethylene or polypropylene.

The fixation element can also be made up of two different individual elements that are made of different materials. Thus, a metal outer ring can absorb the forces exerted locally by the adjustment elements, without being damaged by these adjustment elements. A plastic or rubber inner ring then conducts the pressure onto the blank and, due to its more flexible material, minimizes the risk of damage to the blank. Therefore, since this is an approach that is gentle on the material, even high contact pressures during the clamping are uncritical.

The adjustment elements are selected from the group comprising screws, set screws, eccentrics and eccentric levers. In an embodiment, set screws—also known as grub screws—are used as the adjustment elements. The set screws have a hexagon socket and can thus easily be screwed into the holding device by a hex key. The adjustment elements are advantageously made of a hard plastic or of metal.

The use of an eccentric or eccentric lever has the advantage that here, a pressure defined by the geometry of the eccentric device is exerted onto the adjustment element and thus onto the blank.

The adjustment elements can advantageously be held in appropriate threaded holes of the holding device and they can press from the outside onto the fixation element that is situated in the groove.

In another embodiment, the adjustment element makes contact tangentially with the ring-shaped fixation element. Thus, for example, the adjustment element configured as a stud bolt or screw can easily pull together a locking ring that is provided with threads at its ends.

In order to exert pressure onto the fixation element from all sides, there are at least two adjustment elements. These adjustment elements are advantageously distributed evenly in the ring-shaped holding device so that they are at intervals of 120° in the case of three elements, and at intervals of 90° in the case of four elements.

Advantageously, when it comes to the holding device, the adjustment elements are sunk in the affixed position of the dental blank or else they are flush with the outer wall of the holding device. As a result, the outer device can be clamped into the dental milling machines in such a way that any adjustment elements that might be protruding do not interfere with or hinder the attachment to the machine.

In one embodiment of the subject innovation, the holding device has a height of 5 mm to 15 mm. It is thus less than the height of the blanks that are typically used, thereby forming a frame that is situated in the center and beyond which the blank extends on both sides, as a result of which the holding device is not damaged during the milling.

According to the subject innovation, it is advantageous if the holding device has a thickness of 2.5 mm to 7.5 mm.

The holding device can be made of a wide array of materials, as long as they are sufficiently strong. Suitable materials include metal, here especially aluminum or stainless steel, plastic, especially polyesters, polyacrylates, polyimides and phenolic plastics as well as fiberglass-reinforced plastic.

Advantageously, the groove of the holding device according to the subject innovation is configured as a round groove or as an angled groove, e.g., a rectangular or square groove. These groove shapes are easy to mill and they can accommodate fixation elements with (half) round or angular cross sections of the type that can easily be realized by the clamping jaws, clamping frames, locking rings or clamping rings.

In an embodiment of the subject innovation, when it comes to the holding device, the angled groove has a width of between 4 mm and 8 mm.

The holding device can also have a code by which the individual machining program is identified that is performed on the blank in question. Such a code is a machine-readable code such as, for example, a barcode or a QR code.

The holding device is configured to accommodate a cylindrical blank (circular blank) or, as an alternative, to accommodate one or two semi-cylindrical blanks (semi-circular blanks). Moreover, at least one circular blank with an angular cross section, e.g., an orthogonal polyhedron, such as a cube or a rectangular solid, can be accommodated by the holding device. In one embodiment, the angular cross section is a polyhedra with rounded-off corners. The specific shape of the circular blanks dictates the shape of the at least one recess.

In a manner, the holding device is configured to accommodate a cylindrical blank having a diameter of 88 mm. This corresponds to the diameter of the standard blank in the dental sector.

The blank clamped by the holding device can be made of any useful material, e.g., a material that is selected from the group comprising wax, plastic, ceramic, plaster, metal, metal alloys and non-noble metal alloys.

In an embodiment of the subject innovation, the dental blank is made of a cobalt-chromium alloy. Such alloys display useful properties for dental prosthetic components and can be used in the method according to the subject innovation without any problem.

In an embodiment, the metal titanium is used as the material for the blank.

Advantageously, dental alloys are used here that meet the requirements of standard DIN EN ISO 22674:2007. Such standard-compliant alloys are free of beryllium, gallium and cadmium.

In an embodiment of the subject innovation, the holding device, together with the cylindrical blank, yields a standard clamping holder.

The individual components of the holding device, that is to say, the ring-shaped frame, the fixation element and the adjustment element, are made of a corrosion-resistant material so that they do not corrode, even in case of the frequently employed method of wet-milling of the blanks.

In another aspect, the subject innovation puts forward a blank arrangement that has a holding device according to the subject innovation as well as at least one dental blank, whereby the at least one blank is clamped in the holding device by the adjustment elements and by the fixation element. The blank arrangement here has one disc-shaped, flat-cylindrical dental blank or two disc-shaped, semi-cylindrical, flat semi-cylindrical dental blanks.

In the case of the blank arrangement, the holding device, positioned as a centered ring, surrounds the cylindrical dental blank.

In another aspect, the subject innovation puts forward a method for the height-appropriate positioning of the at least one blank in the holding device according to the subject innovation, whereby the method comprises the following steps:
(a) a template is provided having at least one recess that matches the shape of the at least one blank and having a depth that corresponds to the blank height extending downwards from the holding device;
(b) a holding device with the at least one inserted blank is brought into contact with the template, so that the holding device rests on the template and the at least one blank rests on the bottom of the recess on the template side;
(c) the at least one blank is affixed by actuating the adjustment elements;
(d) the holding device with the at least one affixed blank is removed from the template.

In another aspect, the subject innovation puts forward a method for the production of a dental sintered molded part, whereby the method comprises the following steps:
(a) a blank arrangement according to the subject innovation is provided;
(b) the blank arrangement is clamped into a dental milling machine;
(c) the dental molded part is machined by material removal;
(d) the holding device is removed from the blank machined in accordance with step (c);
(e) in a sintering furnace, the blank of step (d) is sintered, including the machined dental molded part contained therein;
(f) the finished sintered dental molded part is separated from the sintered blank.

Owing to the blank arrangement according to the subject innovation, which comprises a reversible connection between the blank and the holding device, after removal of the holding device, the entire blank, including the machined dental molded part contained therein, undergoes final sintering in a sintering furnace.

This method has a number of advantages in comparison to the method known from the state of the art.

In this method, the milled-out molded parts may not be broken out of the blank in order to be sintered. This procedure, which is carried out manually, is time-consuming and entails the risk that the molded part will be damaged in the process.

After the milling, the molded part is still held in the blank by connection webs. These connection webs ensure that the molded part is stabilized during the sintering process so that it cannot become distorted. This is advantageous in the case of large parts such as, for instance, curved dental bridges, since these molded parts involve a relatively great risk that, as separated molded parts, they might become distorted during the sintering process.

The method according to the subject innovation was made possible through novel, innovative sinter furnace systems that have sintering inserts that, on the one hand, are sufficiently large that they can accommodate complete dental blanks of the usual sizes of up to 100 mm and, on the other hand, continuously ensure high-quality sintering, thanks to gassing technologies, even in the case of large workpieces.

Such sintering furnaces are produced, for example, by Thermostar GmbH in Aachen, Germany An example of this is the inert gas sintering furnace “Denta-Star K2” made by the Thermostar company.

### Definitions

According to the subject innovation, the terms “semi-cylindrical” and “semi-circular” include not only the circle sectors with an internal angle of 180°, but also differing circle sectors with an angle a between 165° and 195°. Such circle sectors can then be present as classic circle sectors with an acute base (when α<180°) or an obtuse base (when α>180°). However, the circle sectors can also be delineated by a straight line (possibly with rounded-off corners) or by a curved line.

### BRIEF DESCRIPTION

These and other aspects of the subject innovation are shown in detail in the figures as follows:

FIG. 1 shows a schematic drawing of a holding device according to a first embodiment for a cylindrical blank (circular blank). The holding device is shown in a top view (upper left), in the two side views that are perpendicular to each other (lower left and top right), and in a perspective view (lower right) with the fixation element (3) inserted into the groove and with the adjustment elements (2) configured as grub screws.

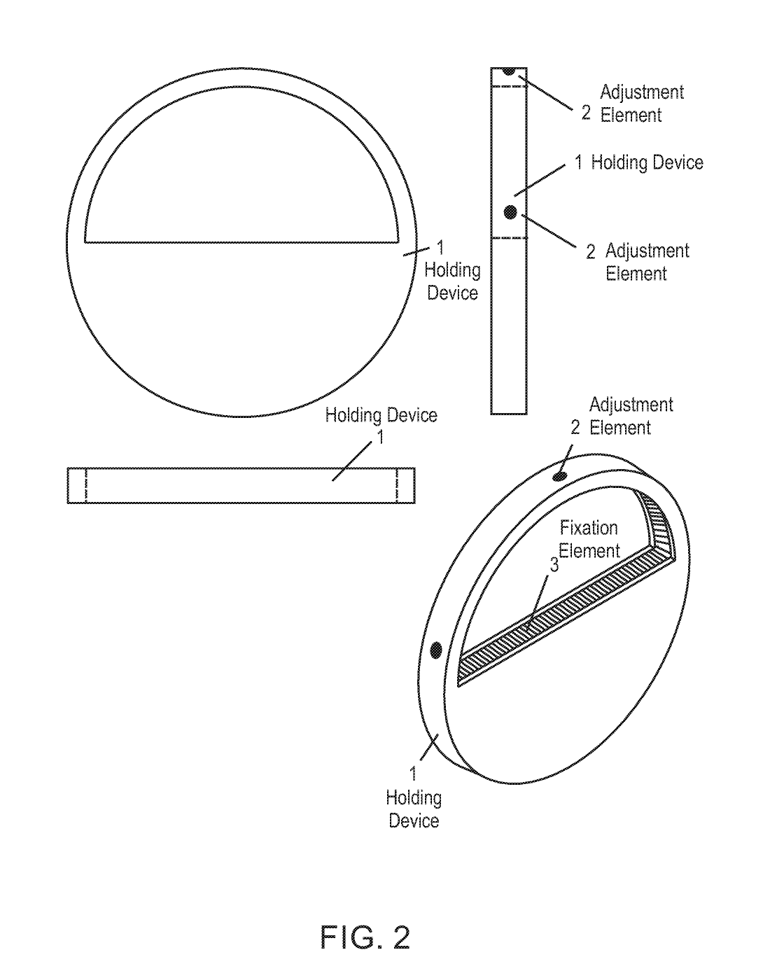

FIG. 2 shows a schematic drawing of a holding device according to a second embodiment for a semi-cylindrical blank (semi-circular blank) and a correspondingly semi-circular recess. The holding device is shown in a top view (upper left), in the two side views that are perpendicular to each other (lower left and top right), and in a perspective view (lower right) with the fixation element (3) inserted into the groove and with the adjustment elements (2) configured as grub screws.

FIG. 3A shows a cross section through a holding device (1) according to the first embodiment with the rectangular annular groove (4), a clamping ring as the fixation element (3) and a stud bolt as the adjustment element (2). FIG. 3B schematically shows an open clamping ring in a top view. FIG. 3C schematically shows a top view of a holding device (1) with two semi-circular recesses for clamping two semi-cylindrical blanks (5).

FIG. 4 shows a blank arrangement (6) according to the subject innovation with a ring-shaped holding device that is clamped around the center of a cylindrical dental blank (5). The schematic depiction shows the blank arrangement in a top view (A), in a side view (B) and in a perspective view (C).

### DETAILED DESCRIPTION

FIG. 1 shows a schematic drawing of a holding device according to the subject innovation, with a round recess to accommodate a cylindrical blank (circular blank). In this embodiment, a clamping ring is advantageously used as the fixation element. This open clamping ring (see FIG. 3B) can be inserted into the lengthwise groove by slightly pinching it together, and it is clamped there by its own tension. By tightening the stud bolts that are accessible from the outside, the clamping ring is pressed onto the blank, thereby affixing it in the holding device so that it cannot slip.

FIG. 2 shows a holding device whose upper half has a semi-circular recess to accommodate a semi-cylindrical blank. In the embodiment shown, the groove holds a clamping half-ring that is in contact with a clamping jaw positioned on the flat recess side. Here, too, the blank is secured in the holding device by the stud bolts and by the associated movement of the fixation elements towards the inside.

As an alternative, the clamping jaw can be dispensed with and a flexible flat element can be inserted into the groove without pressure being exerted by adjustment elements, so that the blank is pressed by the clamping half-ring against this flexible element and is thus attached.

The cross section shown in FIG. 3A illustrates the position of the fixation element and of the adjustment elements. Owing to the position on the groove side, the fixation element is supported very sturdily within the holding device, which means that it cannot fall out of the holding device. A clamping ring is shown in FIG. 3B in a top view, with an appertaining ring opening. The holding device according to the subject innovation shown in FIG. 3C has the additional advantage that here, two semi-circular blanks can be affixed within one holding device. Such semi-cylindrical shapes permit the production of two complex crowns in one holding device.

FIG. 4 shows the blank arrangement according to the subject innovation when connected to a cylindrical dental blank (5). The holding device here is dimensioned in such a way that, together with the blank, it constitutes a standard clamping device for a milling machine.

The person skilled in the art can glean additional variants of the subject innovation and their execution from the preceding disclosure, from the figures and from the patent claims.

In the patent claims, terms such as “encompass”, “comprise”, “contain”, “have” and the like do not exclude additional elements or steps. The use of the indefinite article does not preclude the plural. Each individual device can execute the functions of several of the units or devices cited in the patent claims. The reference numerals indicated in the patent claims are not to be construed as a limitation.

1-18. (canceled)

19. A holding device for at least one dental blank for clamping the holding device in a power tool in order to machine the dental blank by material removal, whereby the holding device has at least one recess to accommodate the dental blank, and whereby a wall of the recess has a lengthwise groove in which a fixation element is provided that can be moved towards a center of the recess by adjustment elements and that permits a reversible attachment of the dental blank.

20. The holding device according to claim 19, whereby the recess is selected from a group encompassing:
(a) a circular recess;
(b) a semi-circular recess;
(c) two semi-circular recesses separated by a web;
(d) a rectangular recess;
(e) two rectangular recesses; and
(f) three, four or more rectangular recesses.

21. The holding device according to claim 19, whereby the holding device is cylindrical or ring-shaped.

22. The holding device according to claim 19, whereby the fixation element is a clamping jaw, a clamping frame, a locking ring or a clamping ring.

23. The holding device according to claim 19, whereby the adjustment elements are selected from a group comprising screws, setscrews, eccentrics and eccentric levers.

24. The holding device according to claim 19, whereby, when the dental blank is not in the affixed state, the fixation element is sunk in the lengthwise groove of the recess or flush with the wall of the recess.

25. The holding device according to claim 19, whereby the holding device has a height of 5 mm to 15 mm.

26. The holding device according to claim 19, whereby the holding device has a thickness of 2.5 mm to 7.5 mm.

27. The holding device according to claim 19, whereby the groove is a round groove or an angled groove.

28. The holding device according to claim 27, whereby the angled groove has a width between 4 mm and 8 mm.

29. The holding device according to claim 19, whereby the dental blank is configured cylindrically as a circular blank or semi-cylindrically as a semi-circular blank.

30. The holding device according to claim 19, whereby the holding device has a diameter of 85 mm to 95 mm in order to accommodate a cylindrical blank.

31. The holding device according to claim 19, whereby the dental blank is made of a material that is selected from a group comprising wax, plastic, ceramic, plaster, metal, metal alloys, and non-noble metal alloys.

32. The holding device according to claim 19, whereby the holding device, together with the cylindrical blank, yields a standard clamping holder.

33. A blank arrangement comprising a holding device for at least one dental blank for clamping the holding device in a power tool in order to machine the dental blank by material removal, whereby the holding device has at least one recess to accommodate the dental blank, and whereby a wall of the recess has a lengthwise groove in which a fixation element is provided that can be moved towards a center of the recess by adjustment elements and that permits a reversible attachment of the dental blank, and comprising one cylindrical or two semi-cylindrical dental blanks clamped in the holding device by the adjustment elements and by the fixation element.

34. A blank arrangement according to claim 33, whereby the holding device, positioned as a centered ring, surrounds the cylindrical dental blank.

35. A method for the height-appropriate positioning of one blank or two blanks in a holding device, comprising:
(a) a template is provided having at least one recess that matches a shape of the one blank or two blanks, and having a depth that corresponds to a blank height extending downwards from the holding device;
(b) the holding device, containing the one blank or two blanks that are inserted into the holding device, is brought into contact with the template, so that the holding device rests on the template and the one blank or two blanks rests on a bottom of a recess on the template side;
(c) the one blank or two blanks is affixed by actuating the adjustment elements;
(d) the holding device with the affixed one blank or two blanks is removed from the template.

36. A method for the production of a dental sintered molded part, comprising:
(a) a blank arrangement comprising a holding device for at least one dental blank for clamping the holding device in a power tool in order to machine the dental blank by material removal, whereby the holding device has at least one recess to accommodate the dental blank, and whereby a wall of the recess has a lengthwise groove in which a fixation element is provided that can be moved towards a center of the recess by adjustment elements and that permits a reversible attachment of the dental blank, and comprising one cylindrical or two semi-cylindrical dental blanks clamped in the holding device by the adjustment elements and by the fixation element is provided;
(b) the blank arrangement is clamped into a dental milling machine;
(c) a dental molded part of the blank arrangement is machined by means of material removal;
(d) the holding device is removed from the blank arrangement;
(e) in a sintering furnace, the blank arrangement of (d) is sintered, including the machined dental molded part contained therein;
(f) the sintered machined dental molded part is separated from the sintered blank arrangement.
